(19) United States
(12) Patent Application Publication
(10) Pub. No.: US 2026/0330375 A1
(43) Pub. Date: Oct. 22, 2026

(54) RISK VECTOR COMPUTATION SYSTEM

(71) Applicant: LOCUS CELL CO., LTD., New Taipei City (TW)

(72) Inventors: CHUN-YI LIN, New Taipei City (TW); Chih Wei Cheng, New Taipei City (TW)

(21) Appl. No.: 19/529,465

(22) Filed: Feb. 4, 2026

Related U.S. Application Data
(60) Provisional application No. 63/754,604, filed on Feb. 6, 2025.

(51) Int. Cl. G06Q 10/0635

(52) U.S. Cl. CPC G06Q 10/0635

(57) ABSTRACT

This invention provides a risk vector computation system comprising a historical risk vector database, a risk vector generation module, a data processing module, and a risk computation module. The data processing module is configured to compare a first event risk multidimensional vector with H multidimensional risk vectors stored in the historical risk vector database to extract a second event risk multidimensional vector of a second event, which shares the same non-temporal components of M components of the first event risk multidimensional vector, as well as a third event risk multidimensional vector of a third event that is similar to the first event risk multidimensional vector. Additionally, the data processing module generates a time vector representing the duration from the occurrence of the second event to the first event. The risk computation module is configured to generate the total risk priority number to quantify the interactions among various event risks.

### BACKGROUND OF THE INVENTION

### 1. Field of the Invention

The present invention relates to a risk computation system, particularly to a risk vector computation system based on quality management.

### 2. Description of the Prior Art

Following the introduction of the ISO 9001:2015 quality management system standard by the International Organization for Standardization, the standard requires enterprises to incorporate a risk management concept into their quality management systems. The concept involves systematically identifying potential internal and external risks encountered during quality management processes and adopting appropriate measures based on risk assessment results to enhance the quality of products or services and strengthen the enterprise's ability to predict, manage, and respond to risks. For effectively implement a risk-oriented strategy, the enterprises must have a precise risk calculation capability to accurately quantify each risk and assess its potential impact. Accurate risk calculation is key to ensuring the effectiveness of risk identification and control measures, as only by accurately assessing the magnitude and priority of risks can the enterprises develop appropriate and targeted response strategies. Additionally, the enterprises must establish an appropriate risk classification framework based on their business characteristics and industry requirements to ensure that all potential risks are comprehensively identified and incorporated into a systematic management process, thereby achieving comprehensive risk control.

However, in the field of quality management, conventional risk calculation methods are the Failure Modes and Effects Analysis (FMEA), which requires significant time and manpower to collect and analyze large amounts of data. Additionally, the FMEA primarily conducts independent analyses for each failure mode, assuming that these modes are mutually exclusive. Consequently, it overlooks the interrelated nature of risks in the real world, thereby failing to provide a comprehensive risk assessment. When conventional risk calculation strategies fail to calculate the correlations among various risks, it may result in executives misjudging the actual risks faced by the enterprise, thereby impacting overall operational stability due to critical risk misidentification.

Furthermore, the FMEA primarily performs risk assessments based on known data and cannot dynamically adjust risk levels over time. This hinders enterprises from promptly implementing appropriate risk mitigation and improvement measures, thereby impairing their ability to formulate and execute risk control measures and reducing overall quality management effectiveness.

### SUMMARY OF THE INVENTION

Therefore, the present invention provides a risk vector computation system utilized for the assessment and calculation of a quality management risks. The system includes a historical risk vector database, a risk vector generation module, a data processing module, and a risk computation module. The historical risk vector database pre-stores H event risk multidimensional vectors respectively corresponding to H events. The risk vector generation module is connected the historical risk vector database and is configured to receive a first instruction of a first event to generate a first event risk multidimensional vector, wherein each of the H event risk multidimensional vectors and the first event risk multidimensional vector respectively comprise M components, the M components comprise a time component. The data processing module is connected to the historical risk vector database and the risk vector generation module, and is configured to compare the first event risk multidimensional vector with the H event risk multidimensional vectors in the historical risk vector database to retrieve a second event risk multidimensional vector of a second event comprising a non-time component of the M components the same as that of the first event risk multidimensional vector of the first event in the historical risk vector database, and to retrieve a third event risk multidimensional vector of a third event, which is similar to the first event risk multidimensional vector of the first event in the historical risk vector database, and to generate a time vector representing a time interval from the occurrence of the second event to the first event. The risk computation module is connected to the risk vector generation module and the data processing module, and is configured to receive the first event risk multidimensional vector, the second event risk multidimensional vector, and the third event risk multidimensional vector to generate a total risk priority number (total RPN). Wherein, M is a natural number greater than 1, and His a natural number greater than or equal to 2.

Wherein, the first event risk multidimensional vector comprises the M components and a first RPN, the M components further comprise a personnel component, a mechanical component, a material component, a regulatory component, an environmental component, an event component, and a time component.

Wherein, the data processing module retrieves a plurality of second event risk multidimensional vectors of a plurality of second events comprising a non-time component of the M components the same as that of the first event risk multidimensional vector of the first event in the historical risk vector database, the second event risk multidimensional vectors further comprise a plurality of second RPN, and the first RPN and the second RPNs are greater than zero.

Wherein, the non-time component of the first event risk multidimensional vector is the same as each of the non-time components of the second event risk multidimensional vectors, and the value of the first RPN is equal to those of the second RPNs.

Wherein, the data processing module retrieves a plurality of third event risk multidimensional vectors of a plurality of third events, which are similar to the first event risk multidimensional vector of the first event in the historical risk vector database, each of the third event risk multidimensional vectors comprise M components, the M components further comprise a personnel component, a mechanical component, a material component, a regulatory component, an environmental component, an event component, and a time component, the third event risk multidimensional vectors further comprise a plurality of third RPN, at least one non-time component of the third event risk multidimensional vectors is different from the non-time component of the first event risk multidimensional vector.

Wherein, the risk vector computation system further includes a parameter setting interface module configured to allow a user to input a risk warning specification constant, a risk decrement coefficient, and a time activation coefficient.

Wherein, the risk vector computation system further includes a control module connected to the parameter setting interface module and configured to connect the risk warning specification constant, the risk decrement coefficient, and the time activation coefficient.

Wherein, the risk computation module is configured to generate the total RPN based on the following formula:

$$total RPN = {\sum }_{1}^{n} ( V n ) + {\sum }_{1}^{{n}^{′}} ( {aV}^{′} {n}^{′} ) + \frac{b x}{365}$$

wherein, V is the first RPN of the first event risk multidimensional vector; n is the total number of the first event risk multidimensional vector and the second event risk multidimensional vector; V′ is the third RPN of the third event risk multidimensional vector; a is the risk decrement coefficient; n′ is the number of the third event risk multidimensional vector; b is the risk warning specification constant; x is the time interval from the occurrence of one of the n−1 second events to the first event.

Wherein, the risk computation module is configured to replace the at least one component of the first event risk multidimensional vector with at least one first parameter to generate a plurality of first event related risk vectors.

Wherein, each of the first event related risk vectors further comprises a fourth RPN, the fourth RPN is the first RPN multiplied by at least one first weighting coefficient, and the first weighting coefficient is equal to the number of the first parameter.

In summary, in the present invention, a risk computation module of a risk vector computation system can receive a first event risk multidimensional vector, a second event risk multidimensional vector, a third event risk multidimensional vector, and a time component to generate a total risk priority number, thereby assessing all potential risks associated with a first event, including all events identical to the first event that have occurred from the past to the present, all events related to the first event that have occurred from the past to the present, and a time risk generated based on the time interval since the most recent occurrence of the same event. In the real world, risk events are often interconnected. Even a single minor risk event can, when compounded with others, generate risks that cannot be ignored, potentially triggering a chain reaction. The risk vector computation system of the present invention can specifically calculate the correlation between different event risks to quantify easily overlooked risk events.

Additionally, the risk events often are often composed of various risk factors, and these risk factors are interconnected. In the present invention, a risk vector generation module of the risk vector computation system receives a first instruction of the first event to generate the first event risk multidimensional vector. The first event risk multidimensional vector is composed of multiple risk components, and a single risk component may trigger a chain reaction, thereby affecting an overall risk trend. Therefore, identifying the key risk factors that emerge from the interactions among various risk components is crucial for guiding enterprises toward sound decision-making and influencing the efficiency of quality control. The risk vector computation system of the present invention can specifically calculate the interactions among various risk components to quantify the transmission mechanisms and cumulative effects between them. This enables enterprises to proactively identify critical risk components and implement appropriate countermeasures to enhance risk management effectiveness.

Furthermore, the risk vector computation system of the present invention can continuously optimize itself as new risk multidimensional vectors are incorporated, and dynamically adjust parameters within the system to ensure the accuracy of risk correlation analysis. Additionally, the system can also identify potential high-risk combinations and predict possible risk chain reactions, enabling enterprises to formulate appropriate preventive measures in advance.

### BRIEF DESCRIPTION OF THE APPENDED DRAWINGS

FIG. 1 is a functional block diagram illustrating a risk vector computation system according to an embodiment of the present invention.

FIG. 2 is a functional block diagram illustrating a risk vector computation system according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

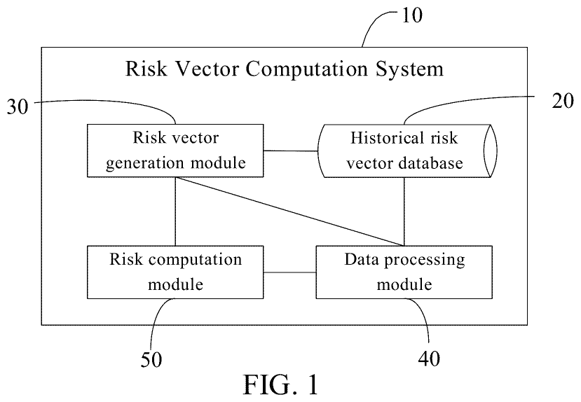

Please refer to FIG. 1. FIG. 1 is a functional block diagram illustrating a risk vector computation system 10 according to an embodiment of the present invention. As shown in FIG. 1, the risk vector computation system 10 of the present invention is utilized for the assessment and calculation of a quality management risks. The system includes a historical risk vector database 20, a risk vector generation module 30, a data processing module 40, and a risk computation module 50. In the present embodiment, the historical risk vector database 20 pre-stores H event risk multidimensional vectors respectively corresponding to H events. The risk vector generation module 30 is connected to the historical risk vector database 20 and configured to receive a first instruction of a first event to generate a first event risk multidimensional vector according to the first instruction, wherein each of the H event risk multidimensional vectors and the first event risk multidimensional vector respectively include M components, the M components include a time component. The data processing module 40 is connected to the historical risk vector database 20 and the risk vector generation module 30, and is configured to compare the first event risk multidimensional vector with the H risk multidimensional vectors in the historical risk vector database 20 to retrieve a second event risk multidimensional vector of a second event comprising a non-time component of the M components the same as that of the first event risk multidimensional vector of the first event in the historical risk vector database 20, and to retrieve a third event risk multidimensional vector of a third event, which is similar to the first event risk multidimensional vector of the first event in the historical risk vector database 20, and to generate a time vector representing a time interval from the occurrence of the second event to the first event. Namely, in the present embodiment, the data processing module 40 of the risk vector computation system 10 can retrieve the second event risk multidimensional vector, whose the non-time component of one of the M components is the same as the first event risk multidimensional vector, but the time component of its occurrence differs, and the risk priority number (RPN) may be the same or different. (Further details on RPN calculation will be provided below); and the third event risk multidimensional vector, which is similar to the first event risk multidimensional vector. Additionally, the data processing module 40 generates the time vector, which is the time interval from the occurrence of the second event to the first event. The risk computation module 50 is connected to the risk vector generation module 30 and the data processing module 40, and is configured to receive the first event risk multidimensional vector, the second event risk multidimensional vector, the third event risk multidimensional vector, and the time vector, and generate a total risk priority number (total RPN) according to the above vector, wherein, M is a natural number greater than 1, and H is a natural number greater than or equal to 2.

The prevent invention provides a risk vector computation system can be applied to factories of Contract Development and Manufacturing Organizations (CDMOs), including product development and commercial manufacturing services for pharmaceuticals and biological products. However, in practical application, the risk vector computation system of the present invention is not limited to the aforementioned fields but can also be broadly applied across other industries to meet quality management needs in diverse sectors, thereby enhancing risk identification and response capabilities.

In the present embodiment, the first event risk multidimensional vector includes the M components and the first RPN, and M is a natural number greater than 1. The M components further include a personnel component, a mechanical component, a material component, a regulatory component, an environmental component, an event component, and a time component. However, in practice, the M components are not limited to the above field and may also be expanded as needed to encompass all risk factors and classification structures.

In the present embodiment, the risk vector computation system 10 not only includes the historical risk vector database 20 but can also further include a quality database (not shown) and a regulatory database (not shown). The quality database further includes a risk calculation table. the risk computation module 50 is connected to the quality database and the risk vector generation module 30. The risk computation module 50 is configured to receive a plurality of attribute data of the first event in the risk vector generation module 30 and compares with the risk calculation table to generate values of a severity index, a detectability index, and an occurrence index. The risk computation module 50 then multiplies the values of the severity index, the detectability index, and the occurrence index to generate the first RPN. In addition, further receive the first RPN through the risk vector generation module 30 and generate the first event risk multidimensional vector with the M components.

As shown in FIG. 1, in the present embodiment, the data processing module 40 can further retrieve multiple second event risk multidimensional vectors of multiple second events in the historical risk vector database 20, which are the same as the non-time component in the first event risk multidimensional vector of the first event. The second event risk multidimensional vectors further include multiple second RPNs, wherein the PRN and second RPNs are greater than zero. Additionally, each the second event risk multidimensional vector includes the M components, including the personnel component, the mechanical component, the material component, the regulatory component, the environmental component, the event component, and the time component. The non-time components in the first event risk multidimensional vector is the same as each non-time component in the second event risk multidimensional vector, and the value of the first is equal to the value of the second RPN. In other words, while the non-time components are the same and the time component of occurrence differs, the RPNs are the same (a practical case study is provided below for further illustration).

As shown in FIG. 1, in the present embodiment, the data processing module 40 retrieves multiple third event risk multidimensional vectors of multiple third events in the historical risk vector database 20, which are similar to the first event risk multidimensional vector of the first event. Each event risk multidimensional vector includes the M components, including the personnel component, the mechanical component, the material component, the regulatory component, the environmental component, the event component, and the time component. The third event risk multidimensional vectors further include multiple third RPNs, and at least one non-tine components in the third event risk multidimensional vectors is different from the non-time components of the first event risk multidimensional vector.

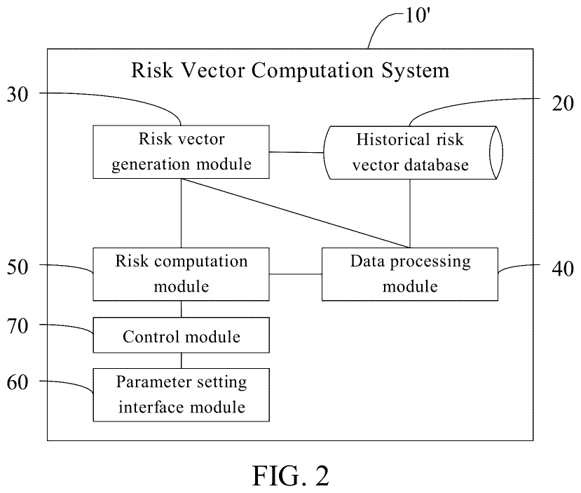

In addition to the above embodiments, the present invention may also encompass other application forms. Please refer to FIG. 2. FIG. 2 is a functional block diagram illustrating a risk vector computation system 10′ according to another embodiment of the present invention. As shown in FIG. 2, the present embodiment differs from the aforementioned embodiment in that the risk vector computation system 10′ further includes a parameter setting interface module 60 and control module 70. The parameter setting interface module 60 is configured to allow a user to input a risk warning specification constant, a risk decrement coefficient, and a time activation coefficient. The control module 70 is connected to the parameter setting interface module 60 and the risk computation module 50, and is configured to connect the risk warning specification constant, the risk decrement coefficient, and the time activation coefficient. In the present embodiment, the time activation coefficient is 365. However, in practice, the value of the time activation coefficient is not limited to it; the time activation coefficient may be subject to rolling adjustments based on each unit's risk tolerance and external objective factors. Additionally, each time a second event is stored in the historical risk database 20, the time activation coefficient of the second event is reset. It should be note that, in the present embodiment, the risk vector computation system 10′ has components and modules that are the same as or correspond to those in the aforementioned embodiment. There have been described in the aforementioned embodiment and are therefore not repeated herein.

In the present embodiment, the risk computation module 50 generates the total RPN using the following formula:

$$total RPN = {\sum }_{1}^{n} ( V n ) + {\sum }_{1}^{{n}^{′}} ( {aV}^{′} {n}^{′} ) + \frac{b x}{365}$$

wherein, V is the first RPN of the first event risk multidimensional vector; n is the total number of the first event risk multidimensional vector and the second event risk multidimensional vector; V′ is the third RPN of the third event risk multidimensional vector; a is the risk decrement coefficient; n′ is the number of the third event risk multidimensional vector; b is the risk warning specification constant; x is the time interval from the occurrence of one of the n−1 second events to the first event.

In the present embodiment, n is the sum of the number of the first event risk multidimensional vector and the second event risk multidimensional vectors, and is configured to ensure the comprehensive inclusion of all historical risk effects. Additionally, V′ is the third RPN of the third event risk multidimensional vector, a is the risk decrement coefficient; n′ is the number of the third event risk multidimensional vector, and is configured to calculate the correlation between different event risks. In a practical application scenario, whether the event risk of “a research and development (RD) specialist caused contamination of Cell A during cell experiments in Laboratory R01” and the event risk of “where a quality control (QC) specialist contaminates Cell B while conducting cell experiments involving Cell A and Cell B in Laboratory R01” exhibit a certain degree of risk cross-accumulation effect, can be calculated and quantitatively evaluated by the risk vector computation system 10′ of the present embodiment. In the real world, risk events are often interconnected. Therefore, the risk values calculated by this invention more accurately reflect actual risk conditions compared to prior art, thereby enhancing the accuracy and applicability of risk assessment. Furthermore, b is the risk warning specification constant; x is the time interval from the occurrence of one of the n−1 second events to the first event, and is configured to calculate the risk that accumulates progressively over time. The risk vector computation system 10′ of the present embodiment can allow the user to input the risk warning specification constant and the risk decrement coefficient through the parameter sitting interface module 60, and the risk warning specification constant and the risk decrement coefficient can be subject to rolling adjustments based on each unit's risk tolerance and external objective factors. However, in practice, it is not limited to the above. The risk vector computation system 10′ of the present embodiment can also further include an algorithm module (not shown), generating and optimizing the risk warning specification constant and the risk decrement coefficient through an algorithm. In the present embodiment, through the above formula, the risk vector computation system 10′ accurately reflects risk conditions by aggregating risk events and applying a dynamic time evaluation method.

In the present embodiment, the risk computation module 50 is further configured to replace at least one component in the first risk multidimensional vector with at least one first parameter to generate multiple first event related risk vectors. The first parameter is N/A. Each first event related risk vector further includes a fourth RPN, the fourth RPN is the first RPN multiplied by at least one first weighting coefficient, and the quantity of the first weighting coefficient equals the quantity of the first parameter. The first weighting coefficient can be subject to rolling adjustments based on each unit's risk tolerance and external objective factors.

Please refer to FIG. 2. In a practical application scenario where the first RPN of the first event risk multidimensional vector is identical to the second RPN of the second event multidimensional vector, the risk vector generation module 30 receives the first instruction to generate the first event risk multidimensional vector according to the first instruction. The first instruction is “On Jan. 1, 2025, the QC specialist operated a microscope in Laboratory R01 and forgot to turn off the power after use, resulting in the light source burning out.” The first event risk multidimensional vector is “00100, QC, microscope, N/A, QC-Laboratory Microscope Operation Manual, Laboratory R01, failure to turn off the power after operating the microscope in accordance with the regulations to result in burnout of the light source, Jan. 1, 2025, 18.” Wherein, these components are, in sequence: a serial number component, the personnel component, the mechanical component, the material component, the regulatory component, the environmental component, the event component, and the time component.

The data processing module 40 is connected to the historical risk vector database 20 and the risk vector generation module 30, and is configured to compare the first event risk multidimensional vector and the H risk multidimensional vectors of the historical risk vector database 20 to retrieve the second event risk multidimensional vector of the second event the same as that of the non-time component in the first event risk multidimensional vector of the first event in the historical risk vector database 20, and to retrieve a third event risk multidimensional vector of a third event, which is similar to the first event risk multidimensional vector of the first event in the historical risk vector database 20. The second event risk multidimensional vector of the second event is “00090, QC, microscope, N/A, QC-Laboratory Microscope Operation Manual, Laboratory R01, failure to turn off the power after operating the microscope in accordance with the regulations to result in burnout of the light source, May 1, 2024, 18.” The third event risk multidimensional vector of the third event is “00045, RD, microscope, N/A, QC-Laboratory Microscope Operation Manual, Laboratory R01, failure to turn off the power after operating the microscope in accordance with the regulations to result in burnout of the light source, Apr. 1, 2024, 18.” The serial number component of the first event is not included in the scope of comparison.

The risk computation module 50 is connected to the risk vector generation module 30 and the data processing module 40, and is configured to receive the first event risk multidimensional vector, the second event risk multidimensional vector, the third event risk multidimensional vector, and the time component to generate the total RPN. In practice, when one component of the third event risk multidimensional vector differs from one component of the first event risk multidimensional vector, the risk decrement coefficient is 0.8; when two components of the third event risk multidimensional vector differs from two components of the first event risk multidimensional vector, the risk decrement coefficient is 0.64, and so on. The risk warning specification constant is preset to 50, and there are 245 calendar days from May 1, 2024, to Jan. 1, 2025, so x is 245. Based on the above formula, the calculation result is as follows:

$${\sum }_{1}^{n} ( V n ) = 18 + 18 = 36$$

$${\sum }_{1}^{{n}^{′}} ( a {V}^{′} {n}^{′} ) = 18 \times 0.8 = 14.4 ; and$$

$$\frac{b x}{365} = 50 \times 245 \div 365 = 33.6$$

Therefore, the total RPN value is calculated as:

total RPN=36+14.4+33.6=84

In the above practical application scenario where the first RPN of the first event risk multidimensional vector is identical to the second RPN of the second event multidimensional vector, when the value of the first RPN is already within a low-risk range (such as the acceptable risk threshold set internally by the enterprise), the same value of the first RPN combined with the value of the second RPN indicates that the risk is stable and under control. No further changes to the control strategy are required. However, when the value of the first RPN remains within a high-risk range despite the implementation of risk control measures that have failed to reduce its first RPN, this indicates that these risk mitigation efforts have limited effectiveness. In practice, the correlation between the values of the first RPN and second RPN is not limited to it.

In other practical application scenario, the values of the first RPN and second RPN can be greater than, equal to, or less than any relationship, indicating different risk states. Following the occurrence of a second event recorded in the historical risk vector database, companies often further optimize quality control measures for that second event to reduce its occurrence rate. Therefore, when the value of the first RPN of the first event is less than the value of the second RPN, it indicates that current quality control measures are effective. If the value of the first RPN of the first event is greater than the value of the second RPN, it indicates that current quality control measures are inadequate.

The risk computation module 50 is further configured to replace at least one component in the first risk multidimensional vector with at least one first parameter to generate multiple first event related risk vectors. The first parameter is N/A. Each first event related risk vector further includes a fourth RPN, the fourth RPN is the first RPN multiplied by at least one first weighting coefficient, and the quantity of the first weighting coefficient equals the quantity of the first parameter. In practice, the event component and the time component are not included in the replacement; they are directly replaced with “N/A.” Namely, the risk computation module 50 receives “00100, QC, microscope, N/A, QC-Laboratory Microscope Operation Manual, Laboratory R01, failure to turn off the power after operating the microscope in accordance with the regulations to result in burnout of the light source, Jan. 1, 2025, 18” to generate “00100, QC, microscope, N/A, QC-Laboratory Microscope Operation Manual, Laboratory R01, N/A, N/A, 18.” Subsequently, the risk vector computation module 50 replaces the “N/A” variables in the personnel component, the mechanical component, the material component, the regulatory component, the environmental component to generate 31 first event related risk vectors. Each replaced component is weighted by 0.8, with the first weighting coefficient set to 0.8. The calculation formula for the fourth RPN is as follows:

fourth RPN=first RPN×first weighting coefficient
wherein, the number of first weighting coefficients equals the number of first parameters. When the specification tolerance is replaced with “N/A,” the calculation yields: fourth RPN=18×0.8=14.4. It generates a first event-related risk vector of “(00101, QC, microscope, N/A, N/A, Laboratory R01, N/A, N/A, 14.4).”
when the specification tolerance and the material component are replaced with “N/A,” the calculation yields:

fourth RPN=18×0.8×0.8=11.52

It generates a first event-related risk vector of “(00101, QC, N/A, N/A, N/A, Laboratory R01, N/A, N/A, 11.52),” and so on for the remaining 29 first-event-related risk vectors. The historical risk vector database receives the 31 first-event-related risk vectors generated above to identify and analyze the mutual influences among various risk components, serving as critical data for determining key risk components.

The present practical application scenario demonstrates how the present invention automatically identifies and assesses risks in quality management through the historical risk vector database 20, the risk vector generation module 30, the data processing module 40, and the risk computation 50. The present invention can not only quantify the correlation between different risk events and identify the key risk components within a single risk event, but also further dynamically adjust parameters within the present system to ensure the accuracy of risk correlation analysis, thereby providing effective and precise risk assessment solutions.

In another embodiment, the risk vector computation system of the present invention further includes parameter processing module. The parameter processing module is connected to the historical risk vector database to retrieve specific components of the historical risk vector database. It then aggregates the total RPN of those specific components within the risk vector control system that share the same specific components, thereby generating critical risk components. The risk vector computation system of the present invention can calculate and accumulate risk scores for specific personnel, clearly presenting their risk burden as a basis for decision-making and management. Additionally, the present invention can also identify high-risk equipment and materials, assisting in determining whether brand replacement is necessary to mitigate process risks. Furthermore, the present invention can also identify high-risk procedures (such as first SOP) and high-risk environments (such as laboratories of different grades) to modify the high-risk procedures for easier correct execution, and conduct audits of the high-risk environments to enhance management efficiency and operational stability. Additionally, the parameter processing module can also identify potential high-risk combinations and predict possible risk chain reactions to enable units to formulate appropriate preventive measures in advance.

In summary, in the present invention, a risk computation module of a risk vector computation system can receive a first event risk multidimensional vector, a second event risk multidimensional vector, a third event risk multidimensional vector, and a time component to generate a total risk priority number, which is configured to calculate all potential risks associated with a first event, including all events identical to the first event that have occurred from the past to the present, all events related to the first event that have occurred from the past to the present, and a time risk generated based on the time interval since the most recent occurrence of the same event. In the real world, risk events are often interconnected. Individual minor risk events may compound to create risks that cannot be overlooked, potentially triggering a chain reaction. The risk vector computation system of the present invention can specifically calculate the correlation between different event risks to quantify easily overlooked risk events.

Additionally, the risk events often are often composed of various risk factors, and these risk factors are interconnected. In the present invention, a risk vector generation module of the risk vector computation system receives a first instruction of the first event to generate the first event risk multidimensional vector. The first event risk multidimensional vector is composed of multiple risk components, and a single risk component may trigger a chain reaction, thereby affecting an overall risk trend. Therefore, the risk vector computation system of the present invention can specifically calculate the interactions among various risk components to quantify the transmission mechanisms and cumulative effects between them. It enables enterprises to proactively identify critical risk components and implement appropriate contingency measures.

Furthermore, the risk vector computation system of the present invention can continuously optimize itself as new risk multidimensional vectors are incorporated, and dynamically adjust parameters within the system to ensure the accuracy of risk correlation analysis. Additionally, the system can also identify potential high-risk combinations and predict possible risk chain reactions, enabling enterprises to formulate appropriate preventive measures in advance.

It should be noted that relational terms in this specification, such as “first” and “second,” are used solely to distinguish one entity or operation from another, without requiring or implying any actual relationship or sequence between these entities or operations. Furthermore, the terms “including,” “having,” and “comprising,” along with other similar expressions, are intended to be equivalent in meaning and are open-ended. The inclusion of one or more items following any such term does not imply an exhaustive list of such items, nor does it imply limitation to the items listed.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A risk vector computation system, applied to the assessment and calculation of a quality control risk, the system comprising:
a memory storing a historical risk vector database, wherein the historical risk vector database pre-stores H event risk multidimensional vectors respectively corresponding to H events;
at least one processor coupled to the memory and configured to execute;
a risk vector generation module, connected to the historical risk vector database and configured to receive a first instruction of a first event to generate a first event risk multidimensional vector, wherein each of the H event risk multidimensional vectors and the first event risk multidimensional vector respectively comprise M components, the M components comprise a time component;
a data processing module, connected to the historical risk vector database and the risk vector generation module, the data processing module being configured to compare the first event risk multidimensional vector with the H event risk multidimensional vectors in the historical risk vector database to retrieve a second event risk multidimensional vector of a second event comprising a non-time component of the M components the same as that of the first event risk multidimensional vector of the first event in the historical risk vector database, and to retrieve a third event risk multidimensional vector of a third event, which is similar to the first event risk multidimensional vector of the first event in the historical risk vector database, and to generate a time vector representing a time interval from the occurrence of the second event to the first event; and
a risk computation module, connected to the risk vector generation module and the data processing module, the risk computation module being configured to receive the first event risk multidimensional vector, the second event risk multidimensional vector, and the third event risk multidimensional vector to generate a total risk priority number (total RPN);
wherein, M is a natural number greater than 1, and H is a natural number greater than or equal to 2,
wherein the processor is further configured to generate an electronic output based on the total RPN to render a visualization of the total RPN on a user interface, thereby transforming the first instruction into a quantifiable risk metric for quality control.

2. The risk vector computation system of claim 1, wherein the first event risk multidimensional vector comprises the M components and a first RPN, the M components further comprise a personnel component, a mechanical component, a material component, a regulatory component, an environmental component, an event component, and a time component.

3. The risk vector computation system of claim 2, wherein the data processing module retrieves a plurality of second event risk multidimensional vectors of a plurality of second events comprising a non-time component of the M components the same as that of the first event risk multidimensional vector of the first event in the historical risk vector database, the second event risk multidimensional vectors further comprise a plurality of second RPN, and the first RPN and the second RPNs are greater than zero.

4. The risk vector computation system of claim 3, wherein the non-time component of the first event risk multidimensional vector is the same as each of the non-time components of the second event risk multidimensional vectors, and the value of the first RPN is equal to those of the second RPNs.

5. The risk vector computation system of claim 4, wherein the data processing module retrieves a plurality of third event risk multidimensional vectors of a plurality of third events from the historical risk vector database based on a comparison with the first event risk multidimensional vector of the first event, each of the third event risk multidimensional vectors comprise M components, the M components further comprise a personnel component, a mechanical component, a material component, a regulatory component, an environmental component, an event component, and a time component, the third event risk multidimensional vectors further comprise a plurality of third RPN, at least one non-time component of the third event risk multidimensional vectors is different from the non-time component of the first event risk multidimensional vector.

6. The risk vector computation system of claim 1, further comprising a parameter setting interface module configured to allow a user to input a risk warning specification constant, a risk decrement coefficient, and a time activation coefficient.

7. The risk vector computation system of claim 6, further comprising a control module connected to the parameter setting interface module and configured to connect the risk warning specification constant, the risk decrement coefficient, and the time activation coefficient.

8. The risk vector computation system of claim 7, wherein the risk computation module is configured to generate the total RPN based on the following formula:
$$total RPN = {\sum }_{1}^{n} ( V n ) + {\sum }_{1}^{{n}^{′}} ( {aV}^{′} {n}^{′} ) + \frac{b x}{365}$$
wherein, V is the first RPN of the first event risk multidimensional vector; n is the total number of the first event risk multidimensional vector and the second event risk multidimensional vector; V′ is the third RPN of the third event risk multidimensional vector; a is the risk decrement coefficient; n′ is the number of the third event risk multidimensional vector; b is the risk warning specification constant; x is the time interval from the occurrence of one of the n−1 second events to the first event.

9. The risk vector computation system of claim 1, wherein the risk computation module is configured to replace the at least one component of the first event risk multidimensional vector with at least one first parameter to generate a plurality of first event related risk vectors.

10. The risk vector computation system of claim 9, wherein each of the first event related risk vectors further comprises a fourth RPN, the fourth RPN is the first RPN multiplied by at least one first weighting coefficient, and the first weighting coefficient is equal to the number of the first parameter.
